(19) United States
(12) Patent Application Publication
(10) Pub. No.: US 2018/0041093 A1
(43) Pub. Date: Feb. 8, 2018

(54) SLIDING COUPLING SYSTEM FOR TRAILER MOUNTED TURBOMACHINERY

(71) Applicant: General Electric Company, Schenectady, NY (US)

(72) Inventor: Johnny A. Miranda, Houston, TX (US)

(21) Appl. No.: 15/231,375

(22) Filed: Aug. 8, 2016

(51) Int. Cl. H02K 7/00; B60P 3/00; E05F 15/70; H02K 7/18; E06B 3/46

(52) U.S. Cl. CPC H02K 7/003; H02K 7/1823; E06B 3/4636; E05F 15/70; B60P 3/00

(57) ABSTRACT

A system includes a turbine mounted on a first mobile unit and a turbine enclosure configured to enclose the turbine mounted on the first mobile unit. The system also includes a coupling system disposed on the turbine enclosure. The coupling system includes a first component and a second component configured to separate in opposite directions via a sliding system to expose an opening within the turbine enclosure. The turbine couples with a generator through the opening within the turbine enclosure.

### BACKGROUND OF THE INVENTION

The subject matter disclosed herein relates to gas turbine systems, and more particularly to systems and methods for coupling mobile turbomachinery, such as equipment for coupling sections of a mobile turbine system

Gas turbines are used in many land and marine based applications. For example, a gas turbine may be coupled to a generator to generate power for an electrical power grid. The process of coupling the gas turbine to the generator may utilize various equipment and techniques that may take as long as a few hours to a few days, depending on external conditions. This downtime of the gas driven generator may result in lost revenues, brown outs, or black outs.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine mounted on a first mobile unit and a turbine enclosure configured to enclose the turbine mounted on the first mobile unit. The system also includes a coupling system disposed on the turbine enclosure. The coupling system includes a first component and a second component configured to separate in opposite directions via a sliding system to expose an opening within the turbine enclosure. The turbine couples with a generator through the opening within the turbine enclosure.

In a second embodiment, a system includes a first mobile unit configured to support a turbine housed within a turbine enclosure. The system also includes a coupling system disposed on an exterior surface of the turbine enclosure. The coupling system includes a first component and a second component mounted on a sliding system. The first and second components are separated to a first distance along the sliding system to expose an alignment guide disposed within the turbine enclosure.

In a third embodiment, a system includes a first mobile unit supporting a turbine, where the turbine is disposed within a turbine enclosure. The system also includes a second mobile unit supporting a generator. The system also includes a coupling system mounted on a sliding system, and the coupling system is disposed on an exterior surface of the turbine enclosure. The coupling system is displaced along the sliding system to expose an opening through the turbine enclosure, and the turbine is coupled to the generator through the opening.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of a mobile power plant system illustrating a turbine trailer, a generator trailer, and a coupling system disposed on a turbine mounted on the turbine trailer;

FIG. 2 is a perspective view of the coupling system of FIG. 1 in a first closed position;

FIG. 3 is a perspective view of the coupling system of FIG. 1 in an open position;

FIG. 4 is a perspective view of the coupling system of FIG. 1 in an open position and having one or more hinged joint;

FIG. 5 is a perspective view of the coupling system of FIG. 1 in a second closed position, where the coupling system includes an access point;

FIG. 6 is a perspective view of the coupling system of FIG. 1, where the coupling system is associated with one or more electric motors; and

FIG. 7 is a perspective view of the coupling system of FIG. 1, where the coupling system is associated with a manual hand crank.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed to systems and methods for a coupling system configured to help couple a gas turbine and a generator of a mobile power plant system. The mobile power plant system may be a trailer mounted system that is transported by ship, air, or road to the installation site. In some situations, the mobile power plant may be delivered to the installation site in a partially assembled state of components, with components mounted or disposed on one or more trailers (or other types of mobile bodies). For example, the gas turbine may be mounted on a wheeled turbine trailer and the generator may be mounted on a wheeled generator trailer. The mobile power plant system may be transported to a location in need of electricity, such as during an emergency, natural disaster, or other event resulting in insufficient electricity. Specifically, the disclosed embodiments include a coupling system associated with the turbine trailer of the power plant system. In certain embodiments, the coupling system may include a sliding system that may be utilized in the field to quickly couple the gas turbine with the generator.

Without the disclosed embodiments, coupling the generator and the turbine may take up to a few hours depending on various environmental factors. For example, during transportation of the mobile power plant system, the coupling system may be mounted on a gas turbine enclosure and may be configured to enclose various components of the gas turbine within the gas turbine enclosure. In this manner, components of the gas turbine may be secured within the gas turbine enclosure during transportation. Without the disclosed embodiments, the coupling system may be manually disassembled and physically removed from the gas turbine enclosure prior to assembly of mobile power plant system. Specifically, without the disclosed embodiments, the coupling system may be manually disassembled and detached from the gas turbine enclosure to expose an opening through the gas turbine enclosure. The generator may be aligned and coupled to the gas turbine through the opening, in order to assemble the mobile power plant system and generate electricity. However, manually disassembling and removing one or more components of the coupling system from the gas turbine enclosure prior to coupling the gas turbine and the generator may result in slower installation and commissioning speeds, thereby increasing downtime and revenues lost. Accordingly, it may be beneficial to provide for systems and methods for improving the installation and commissioning speed of the mobile gas turbine system.

The disclosed embodiments are directed to a coupling system that may be quickly disassembled prior to assembly of the mobile power plant system. Specifically, the disclosed embodiments include a coupling system disposed on a gas turbine enclosure mounted on a turbine trailer. In certain embodiments, the coupling system may include a sliding system that may be utilized to separate one or more components of the coupling system, thereby exposing an opening through the gas turbine enclosure through which the generator may be coupled to the gas turbine. In particular, the disclosed embodiments may allow the coupling system to be disassembled without being detached from the gas turbine enclosure, as further described in detail below.

In certain embodiments, one or more components of the coupling system may be associated with a sliding system, and may be disposed on a surface of the gas turbine enclosure. For example, the coupling system may include a first and a second component coupled to rails of the sliding system. In certain embodiments, the first and second components of the coupling system may be separated by sliding each component along the rails of the sliding system, thereby exposing an opening in the turbine enclosure. The generator may be coupled to the gas turbine through the opening. In certain embodiments, an operator may separate the coupling system by manually engaging each component of the coupling system and sliding them apart along the sliding system. In particular, the sliding system may be utilized to expose the opening through the turbine enclosure without detaching the coupling system from the surface of the gas turbine enclosure. In certain embodiments, one or more components of the coupling system may include a drive system (e.g., electric or fluid drive). For example, the drive system may include a liquid or gas driven piston and shaft assembly, an electrical motor driven shaft, a rack and pinion system, a rotary screw system, or any combination thereof. The drive system may be configured to automatically separate the coupling system along the sliding system without operator intervention. Further, in certain embodiments, each component of the coupling system may include a manual crank, which may be utilized by the operator to separate the coupling system along the sliding system. These and other embodiments may be described in further detail below.

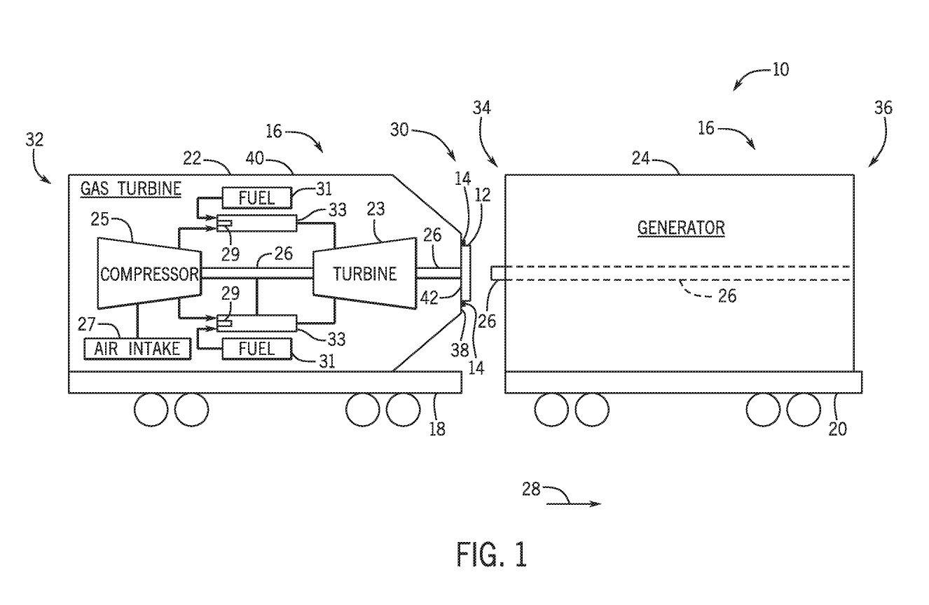

Turning now to the drawings, FIG. 1 is a block diagram of an embodiment of a mobile power plant system 10 illustrating a coupling system 12 associated with a sliding system 14. Specifically, the mobile power plant system 10 includes one or more trailers 16 that are configured to transport turbomachinery (e.g., one or more components of the mobile power plant system 10) to a desired location, such as to an installation site (e.g., on-site location) to meet power demands of customers where permanent power plants may not be able to deliver power. In certain embodiments, the mobile power plant system 10 includes a turbine trailer 18 (e.g., wheeled turbine trailer) and a generator trailer 20 (e.g., wheeled turbine trailer) to transport one or more components of the mobile power plant system 10 to the installation site. For example, the turbine trailer 18 may be configured to transport a gas turbine 22 (e.g., a gas turbine engine, a steam turbine, a hydroturbine, a wind turbine, or any turbine system) to an installation site. Further, the generator trailer 20 may be configured to transport a generator 24 configured to generate power for the mobile power plant system 10. The turbine trailer 18 and the generator trailer 20 may include a frame, a base, sidewalls, wheels, axles, and other structural components that may help transport components of the mobile power plant system 10 to the installation site.

In particular, the turbine trailer 18 may be configured to move the gas turbine 22 into alignment with the generator 24 before the gas turbine 22 is coupled to the generator 24. Likewise, the generator trailer 20 may be configured to move the generator 24 into a position where it may be aligned with the gas turbine 22. For example, the generator trailer 20 supporting the generator 24 may be moved into a first position. In certain embodiments, the turbine trailer 18 supporting the gas turbine 22 may move in a reverse direction 28 into the generator trailer 20, such that a tail end 30 of the turbine trailer 18 (e.g., relative to a gooseneck 32 of the turbine trailer 18) is moved towards a tail end 34 of the generator trailer 20 (e.g., relative to a gooseneck 36 of the generator trailer 20). In certain embodiments, the turbine trailer 18 may move in the reverse direction 28 to couple with the generator trailer 20. In such embodiments, the generator trailer 20 may remain stationary in the first position while the turbine trailer 18 is moved in the reverse direction 28 into the first position so that the gas turbine 22 may be rotationally coupled to the generator 24. While the illustrated embodiments describe the turbine trailer 14 moving in the reverse direction 28 as the generator trailer 20 is stationary, it should be noted that in other embodiments, the generator trailer 20 may move towards the stationary turbine trailer 18 and/or both trailers 18, 20 may move towards one another during the alignment and coupling process.

Specifically, in certain embodiments, the gas turbine 22 may be coupled to the generator 24 via a common shaft 26 during assembly of the mobile power plant system 10. In certain embodiments, the gas turbine 22 may include a turbine 23 coupled to a compressor 25 via the common shaft 26. The compressor 25 may intake oxidant (e.g., air, oxygen, oxygen-enriched air, oxygen-reduced air, etc.) via an air intake 27. The compressor 25 may compress the inlet air, forming pressurized air (e.g., compressed air) by rotating blades within the compressor 25. The pressurized air may enter a fuel nozzle 29 and mixes with a fuel 31 (e.g., gas fuel, liquid fuel, etc.) to form an air-fuel mixture. The fuel nozzle 29 may direct the air-fuel mixture into a combustor 33. The combustor 33 ignites and combusts the air-fuel mixture, to form combustion products. The combustion products are directed to the turbine 23, where the combustion products expand and drive blades of the turbine 23 about the common shaft 26. The gas turbine 22, once coupled to the generator 24, may drive the generator 24 (e.g., electrical generator) via the common shaft 26 to generate electricity. Eventually, the combustion products may exit the gas turbine 22 as exhaust gases. In certain embodiments, various turbomachinery components may be utilized or manipulated prior to the coupling of the gas turbine 22 and the generator 24. For example, in certain situations, the coupling system 12 may be utilized to help couple the gas turbine 22 with the generator 24, as further described below.

In certain embodiments, the coupling system 12 may be utilized to help couple the gas turbine 22 with the generator 24 during assembly and commissioning of the mobile power plant system 10. Specifically, in certain embodiments, the coupling system 12 may be disposed on an exterior surface 38 of a turbine enclosure 40. For example, the exterior surface 38 may be proximate to the tail end 30 of the turbine trailer 18. The turbine enclosure 40 may be a housing configured to secure various components of the gas turbine 22 during transportation of the mobile power plant system 10. In certain embodiments, the coupling system 12 may be disposed over an opening 42 within the turbine enclosure 40 during transportation of the mobile power plant system 10. Accordingly, during assembly of the mobile power plant system 10, the coupling system 12 may be separated to expose the opening 42, thereby allowing an access point through which the gas turbine 22 may be coupled with the generator 24. Specifically, the common shaft 26 of the generator 24 may be coupled to the gas turbine 22 via the opening 42. Indeed, while the illustrated embodiment depicts the coupling system 12 disposed on the exterior surface 38 of the turbine enclosure 40, it should be noted that in certain embodiments, the disclosed coupling system 12 may be disposed on other mobile bodies (e.g., generator trailer 24).

Without the disclosed embodiments, the coupling system 12 may be manually disassembled and physically removed from the exterior surface 38 of the turbine enclosure 40, which may result in slower installation and commissioning speeds, thereby increasing downtime and revenues lost. Accordingly, the disclosed embodiments improve efficiency of installation and commissioning speeds by utilizing the sliding system 14, as further described below.

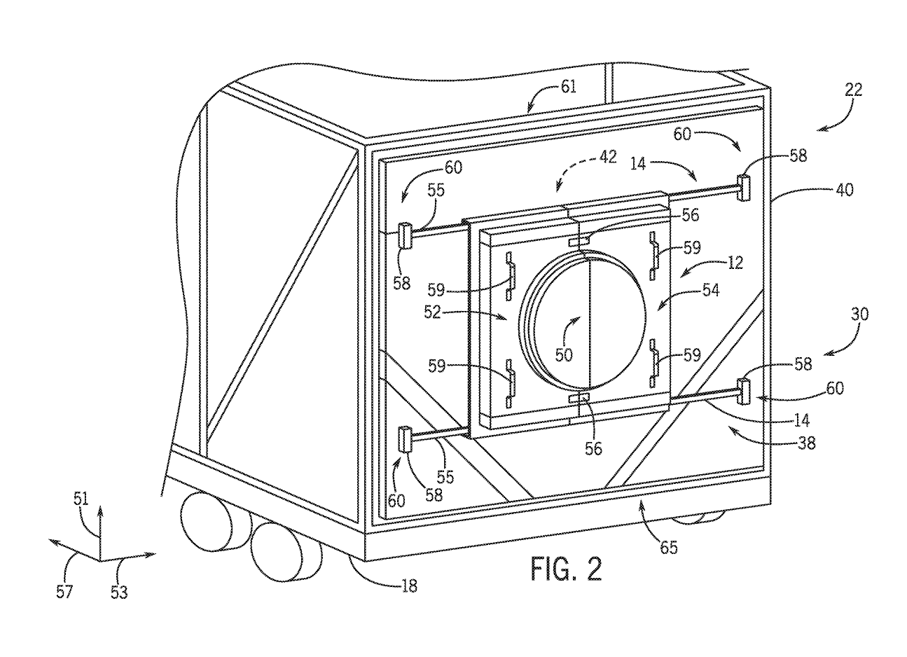

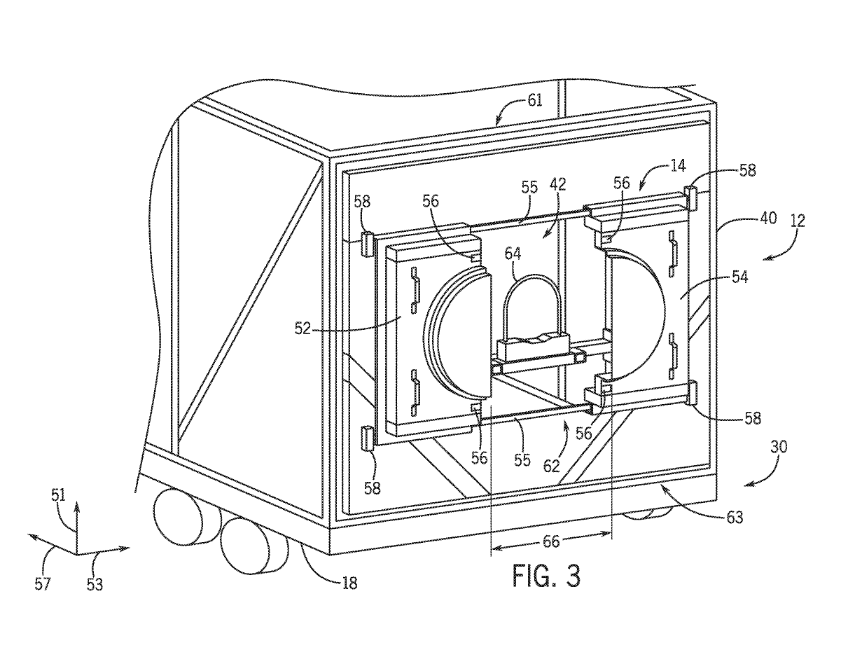

In certain embodiments, the coupling system 12 may include the sliding system 14, and one or more components of the coupling system 12 may be separated via the sliding system 14 to expose the opening 42 within the turbine enclosure 40. Specifically, as further described with respect to FIGS. 2-3, the coupling system 12 may be separated by sliding one or more components or portions of the coupling system 12 along the sliding system 14. In this manner, the coupling system 12 may be separated without being detached from the exterior surface 38 of the turbine enclosure 40. Accordingly, the sliding system 14 may enable the coupling system 12 to quickly provide an access point (e.g., the opening 42) through which the generator 24 may be coupled to the gas turbine 22 (disposed inside the turbine enclosure 40), as further described in detail with respect to FIGS. 2-3.

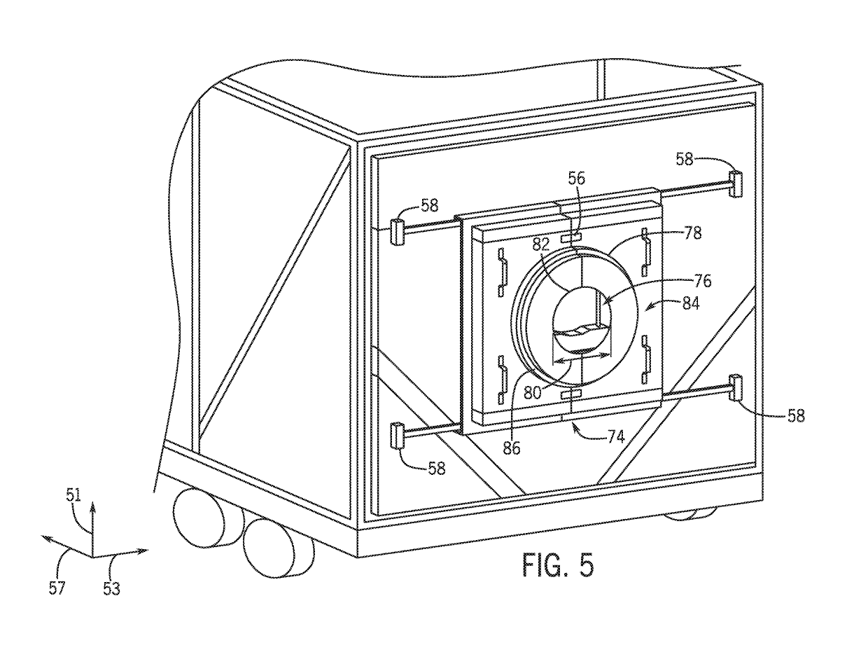

FIG. 2 is a perspective view of the coupling system 12 of FIG. 1 in a first closed position 50. Specifically, in the illustrated embodiment, the coupling system 12 is disposed on the exterior surface 38 of the turbine enclosure 40. In particular, the exterior surface 38 of the turbine enclosure 40 may be proximate to the tail end 30 of the turbine trailer 18. In certain embodiments, the coupling system 12 may be configured to cover the opening 42 disposed within the turbine enclosure 40 during transportation of the mobile power plant system 10. In certain embodiments, the first closed position 50 may be the configuration of the coupling system 12 during transportation of the gas turbine 22 mounted turbine trailer 18. The coupling system 12 may be in the first closed position 50 until the mobile power plant system 10 is ready to be assembled and commissioned (e.g., until the coupling process of the gas turbine 22 with the generator 24). In certain embodiments, after the gas turbine 22 is coupled to the generator 24, the coupling system 12 may be reassembled in a second closed position, as further described with respect to FIG. 5. In certain embodiments, the coupling system 12 may separate to expose the opening 42 during an installation and commissioning of the mobile power plant system 10. In particular, one or more components of the coupling system 12 may be separated via the sliding system 14 to expose the opening 42, so that the gas turbine 22 may be coupled with the generator 24 through the opening 42. In the following discussion, reference may be made to an X-axis 53, a Y-axis 51, and a Z-axis 57.

In certain embodiments, the coupling system 12 may be formed of one or more components, and each of the one or more components may be coupled to a portion of the sliding system 14. For example, in the illustrated embodiment, the coupling system 12 includes a first component 52 (e.g., a first sliding door) and a second component 54 (e.g., a second sliding door) each coupled to a portion of the sliding system 14. In certain embodiments, the sliding system 14 include rails 55 (e.g., linear guide paths, tracks, wheels, linear bearings, low friction bushings, etc.) mounted on the exterior surface 38 of the turbine enclosure 40. The rails 55 may be formed of any durable material that may support one or more portions of the coupling system 12, such as, for example, aluminum, steel, plastic, etc. Furthermore, in certain embodiments, the sliding system 14 may include one or more sets of rails 55 extending along the X-axis 53, such as a first set of mating rails 55 proximate to a top edge 61 of the turbine enclosure 40 and a second set of mating rails 55 proximate to a bottom edge 63 of the turbine enclosure 40. In certain embodiments, the first and second sets of mating rails 55 may mate with a T-shaped protrusion into a T-shaped slot, a J-shaped protrusion into a J-shaped slot, etc.

In particular, each component of the coupling system 12 (e.g., the first component 52, the second component 54) may include an associated portion or portions of the rails 55, which may be utilized to slide the components apart to expose the opening 42, as further described with respect to FIG. 3. In certain embodiments, each component (e.g., the first component 52, the second component 54, etc.) of the coupling system 12 may be coupled to a rail guided structure that may be removably mounted within the frame or support structure of the rails 55. In certain embodiments, the rail guided structure of each component may be a protrusion (e.g., wheels, extension, etc.) that forms a male/female connection with the frame of the rails 55, and that may roll along the length of the rails 55 without disengaging. For example, the rails 55 of the sliding system 14 may extend along the X-axis 53 of the turbine trailer 18. Further, each component of the coupling system 12 may be separated when an operator engages the component and slides the component along the X-axis 53 in opposite directions. For example, the first and second components 52, 54 may be separated by linearly moving them in opposite directions.

In the illustrated embodiment, the coupling system 12 may be formed of two components (e.g., the first component 52, the second component 54), which may be secured together with one or more removable fasteners 56. The one or more removable fasteners 56 may include threaded receptacles, bolts, screws, nuts, clamps, male/female joints, latches, snap-fit couplings, spring-loaded couplings, buckles, retaining clips or threads, or any combination thereof. In particular, the removable fasteners 56 may be removed before the components of the coupling system 12 are separated via the sliding system 14. Further, in certain embodiments, the removable fasteners 56 may be reattached when the components of the coupling system 12 are brought back together after the gas turbine 22 is coupled to the generator 24, as further described with respect to FIG. 5.

In the illustrated embodiment of FIG. 2, two components (e.g., the first component 52, the second component 54) of the coupling system 12 which may be separated to expose the opening 42 are depicted. For example, a vertical split along the Y-axis 51 may separate the coupling system 12 into two generally equally sized compartments. In other embodiments, the coupling system 12 may include three or more components. For example, in certain embodiments, the coupling system 12 may include 3, 4, 5, 6, 7, 8, 9, 10 or more components. For example, the coupling system 12 may be split along any axis (e.g., X-axis 53, Y-axis 51, Z-axis 57) into any number of components, and each component may be coupled to a portion (e.g., the rails 55) of the sliding system 14. Each of the one or more components may be separated via the sliding system 14 to expose the opening 42.

In certain embodiments, each of the one or more components of the coupling system 12 may be coupled to one or more handles 59 which may be utilized by an operator to separate and slide the one or more components of the coupling system 12 along the sliding system 14. In certain embodiments, the handles 59 may be a knob, a grip, a handgrip, a protrusion, a doorknob, a combination thereof, or any mechanism that may be utilized by an operator to engage a component of the coupling system 12. For example, in certain embodiments, the operator may actuate a latch to unlock the first and the second components 52, 54, and may further engage the latch to slide the first and the second components 52, 54 along the sliding system 14.

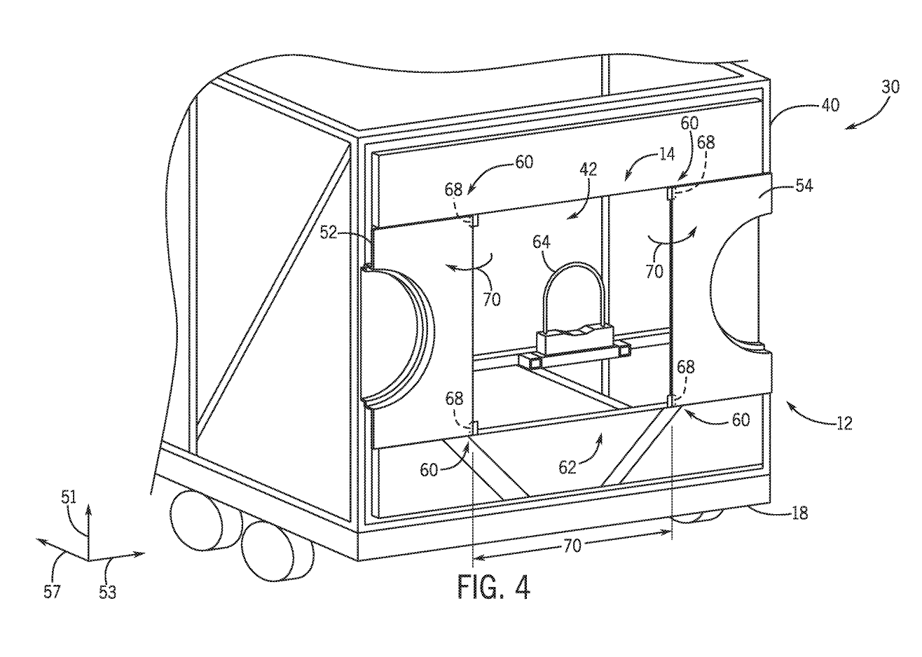

Further, in certain embodiments, a stopping mechanism 58 may be coupled to the rails 55 at an outer edge 60 of the sliding system 14. In certain embodiments, the stopping mechanism 58 may be a stopper formed of a material resilient to impact (e.g., rubber, plastic, elastomer, etc.), and/or may be any mechanical component (e.g., blocker, stopper, locking pegs, etc.) configured to prevent each component of the coupling system 12 from disengaging from the sliding system 14. In certain embodiments, the stopping mechanism 58 may be configured to block further movement of the components of the coupling system 12 after the components have been separated a particular distance. In certain embodiments, the stopping mechanism 58 may include one or more magnets that are configured to both stop the component of the coupling system 12 along the rails 55 and securely hold (e.g., lock) the component along the outer edge 60 of the sliding system 14. In certain embodiments, the stopping mechanism 58 may include other features that prevent the components of coupling system 12 from disengaging from the sliding system 14, as further described with respect to FIG. 4.

FIG. 3 is a perspective view of the coupling system 12 of FIG. 1 in an open position 62. As noted above, the coupling system 12 may be disposed on the exterior surface 38 of the turbine enclosure 40, and may be proximate to the tail end 30 of the turbine trailer 18. In certain embodiments, the coupling system 12 may be configured to cover the opening 42 within the turbine enclosure 40 during transportation of the turbine trailer 18 to the installation site. In particular, one or more components of the coupling system 12 may separate along the X-axis 53 to expose the opening 42 prior to the installation and commissioning of the mobile power plant system 10. For example, the one or more components of the coupling system 12 may be separated via the sliding system 14 to expose the opening 42, so that the gas turbine 22 (mounted on the turbine trailer 18) may be coupled with the generator 24 (mounted on the generator trailer) through the opening 42.

In certain embodiments, a shaft alignment guide 64 associated with the gas turbine 22 may be disposed within the turbine enclosure 40, and may be utilized after the first and second components 52, 54 of the coupling system 12 are separated. Specifically, once the coupling system 12 is in the open position 62, the shaft 26 of the generator 24 may be coupled to the gas turbine 22 via the shaft alignment guide 64. In particular, the components of the coupling system 12 may be separated a first distance 66 along the X-axis 53, such that the coupling process between the gas turbine 22 and the generator 24 may commence without interference from a portion of the coupling system 12. The first distance 66 may be any distance shorter than or equal to a width of the turbine enclosure 40 and/or the turbine trailer 18. Further, it should be noted one or more hinged joints coupled to the coupling system 12 and/or the sliding system 14 may be utilized to extend the components of the coupling system 12 away from the exterior surface 38 of the turbine enclosure, as further described with respect to FIG. 4.

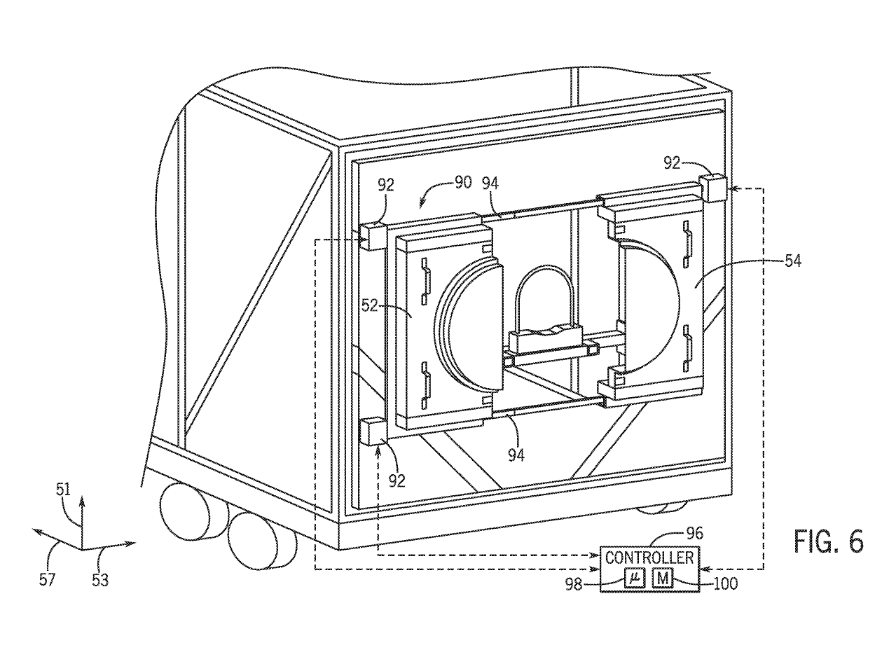

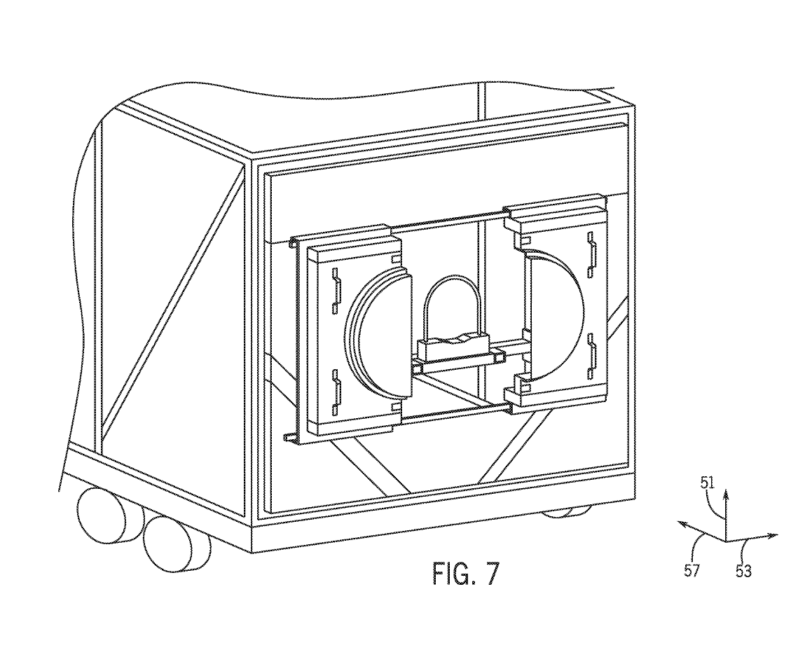

FIG. 4 is a perspective view of the coupling system 12 of FIG. 1 in the open position 62 and having one or more hinged joint 68. In certain embodiments, as noted above, the first and second components 52, 54 of the coupling system 12 may be separated from one another to expose the opening 42 within the turbine enclosure 40. For example, as noted above, each of the one or more components of the coupling system 12 may be coupled to the rails 55 of the sliding system 14. In certain embodiments, an operator may engage the components of the coupling system 12 to separate the components along the X-axis 53 via the sliding system 14. In certain embodiments, the components of the coupling system 12 may be separated via a drive system, as further described with respect to FIG. 6. Furthermore, in certain embodiments, the components of the coupling system 12 may be separated via a manual hand crank, as further described with respect to FIG. 7.

In certain embodiments, the first and second components 52, 54 of the coupling system 12 may be separated along the X-axis 53 to the first distance 66, as described with respect to FIG. 3. Furthermore, in certain embodiments, the first and second components 52, 54 may be further extended via one or more hinged joints 68 that couple the components 52, 54 to the outer edge 60 of the sliding system 14. For example, the first and second components 52, 54 may be configured as hinged doors or hinged sliding doors. Specifically, in certain embodiments, the stopping mechanism 58 disposed at the end of the rails 55 may be a hinged joint configured to open the components 52, 54 along the direction 70, thereby creating a second distance 70 between the first and second components 52, 54. The second distance 70 may be greater than the first distance 66, thereby allowing for more space between the components of the coupling system 12 for assembling and coupling the gas turbine 22 and generator 24. In certain embodiments, the first and second distances 66, 70 may be a radius and/or a direction. In certain embodiments, the hinged joint 68 may be disposed anywhere along the rails 55 along the X-axis 53, and the hinged joint 68 may be positioned based on desired second distance 70 between the components 52, 54.

FIG. 5 is a perspective view of the coupling system 12 of FIG. 1 in a second closed position 74, where the coupling system 12 includes a shaft access 76. As noted above, in certain embodiments, the coupling system 12 may be configured to cover the opening 42 disposed within the turbine enclosure 40 during transportation of the mobile power plant system 10. Specifically, the first closed position 50 may be the configuration of the coupling system 12 during transportation of the turbine trailer 18 and prior to the coupling of the gas turbine 22 with the generator 24. As noted above, prior to coupling the gas turbine 22 and the generator 24 via the shaft 26, the coupling system 12 may be separated along the sliding system 14. In particular, the coupling system 12 may be separated without disassembling and removing one or more components of the coupling system 12 from the exterior surface 38 of the turbine enclosure 40, thereby improving installation and commissioning speeds. Furthermore, in certain embodiments, after the gas turbine 22 is coupled to the generator 24, the coupling system 12 may be reassembled into second closed position 74, as further described in detail below.

Specifically, the second closed position 74 may be formed by engaging the one or more components of the coupling system 12 back together via the sliding system 14. For example, in certain embodiments, the first component 52 and the second component 54 may be reassembled and secured together with the one or more removable fasteners 56 after the generator 24 and the gas turbine 22 are coupled. In certain embodiments, the coupling system 12 may include a grommet 78 that is formed after the generator 24 and the gas turbine 22 are coupled together. Specifically, grommet 78 may be formed of a rubber, a plastic, or any other flexible or malleable material. In certain embodiments, an operator may form the shaft access 76 within the grommet 78 by cutting out a portion of the grommet material.

The dimensions of the shaft access 76 may be determined based on an amount of clearance desired around the shaft 26 during operation of the mobile power plant system 10. For example, the diameter 80 (e.g., inside diameter) of the shaft access 76 may be greater than the diameter of the shaft 26 by a few centimeters, a few inches, or a few feet, depending upon the dimensions of the shaft 26 and depending upon the desired distance between the shaft 26 and an inner edge 82 (e.g., inner edge diameter) of the grommet 78. In certain embodiments, the grommet 78 may be coupled to a top surface 84 of the coupling system 12 with one or more attachment mechanisms 86. In certain embodiments, the attachment mechanisms 86 may include one or more bolts, threaded receptacles, screws, nuts, clamps, male/female joints, buckles, retaining clips or threads, or a combination thereof.

FIG. 6 is a perspective view of the coupling system 12 of FIG. 1, where the coupling system 12 is associated with a drive system 90 associated with the sliding system 14. In certain embodiments, an operator may separate the coupling system 12 by manually engaging each component (e.g., the first and second components 52, 54) of the coupling system 12 and sliding them apart along the sliding system 14. Further, in certain embodiments, the drive system 90 may be configured to automatically separate the coupling system 12 along the sliding system 14 without operator intervention. In certain embodiments, the drive system 90 (e.g., electric or fluid drive) may include a liquid or gas driven piston and shaft assembly, an electrical motor driven shaft, a rack and pinion system, a rotary screw system, or any combination thereof.

For example, the drive system 90 may include one or more electrical motors 92, and each electrical motor 92 may be associated with an actuator system 94. Each component (e.g., the first and second component 52, 54) of the coupling system 12 may be coupled to the actuator system 94, and each actuator system 94 may be communicatively coupled to the electric motor 92. In certain embodiments, a single electrical motor 92 may be utilized within one or more components of the coupling system 12, and may be configured to regulate the operations of one or more actuator systems 94, where each actuator system 94 is coupled to a component of the coupling system 12. Further, each electrical motor 92 and the actuator system 94 may be communicatively coupled to a controller 96, which includes a processor 98 and a memory 100. The controller 96 may be configured to independently coordinate and control the movement of each component of the coupling system 12.

In certain embodiments, the memory 100 may include any suitable non-transitory, tangible, computer-readable medium having executable instructions. The controller 96 may be suitable for executing various monitoring or controlling operations related to the coupling system 12 or the one or more components of the coupling system 12. In certain embodiments, the coupling system 12 may include a display through which an operator (e.g., engineer or technician) may monitor the components of the coupling system 12 and/or the general installation and commissioning process of the mobile power plant system 10. The controller 96 may be any type of computing device suitable for running software applications, such as a laptop, a workstation, a tablet computer, or a handheld portable device (e.g., personal digital assistant or cell phone). Indeed, the controller 96 may include any of a variety of hardware and/or operating system platforms. In some embodiments, the computer may host industrial control software, such as a human-machine interface (HMI) software, a manufacturing execution system (MES), a distributed control system (DCS), a supervisor control and data acquisition (SCADA) system, and so forth. In certain embodiments, the controller 96 may be included within a control system or a controller configured to monitor and/or control the operations of the mobile power plant system 10.

FIG. 7 is a perspective view of the coupling system 12 of FIG. 1, where the coupling system 12 is associated with a manual hand crank 102. In the illustrated embodiment, a single manual hand crank 102 is depicted as coupled to a single component (e.g., the first component 52) of the coupling system 12. In certain embodiments, one or more manual hand cranks 102 may be utilized with each of the one or more components of the coupling system 12. In certain embodiments, the manual hand crank 102 may include an arm, a rotating shaft, and a disk that are coupled to a portion of the sliding system 14. Furthermore, in certain embodiments, the manual hand crank 102 may include one or more components coupled to the sliding system 14 and configured to transfer torque to the sliding system 14. Indeed, the manual hand crank 102 may include any components that may be utilized to convert circulation motion received from an operator into linear sliding motion for moving components of the coupling system 12 along the X-axis 53. For example, the manual hand crank 102 may include gears, transmission, pulleys, or cables that are coupled to the sliding system 14, and which may be configured to transfer torque to the sliding system 14.

Technical effects of the invention include a coupling system 12 configured to help couple the gas turbine 22 and the generator 24 of the mobile power plant system 10. In certain embodiments, the coupling system 12 may be disposed on the turbine enclosure 40 mounted on the turbine trailer 18 and configured to enclose components of the gas turbine 22 during transportation of the mobile power plant system 10. The coupling system 12 may include the sliding system 14 that may be utilized to separate one or more components (e.g., the first and second components 52, 54) of the coupling system 12, thereby exposing the opening 42 through the turbine enclosure 40 through which the generator 24 may be coupled to the gas turbine 22. In certain embodiments, an operator may separate the coupling system 12 by manually engaging each component (e.g., the first and second components 52, 54) of the coupling system 12 and sliding them apart along the sliding system 14. In particular, the sliding system 14 may be utilized to expose the opening 42 through the turbine enclosure 40 without detaching the coupling system 12 from the exterior surface 38 of the turbine enclosure 40.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a turbine mounted on a first mobile unit;
a turbine enclosure configured to enclose the turbine mounted on the first mobile unit; and
a coupling system disposed on the turbine enclosure, wherein the coupling system comprises a first component and a second component configured to separate in opposite directions via a sliding system to expose an opening within the turbine enclosure, and wherein the turbine couples with a generator through the opening within the turbine enclosure.

2. The system of claim 1, wherein the generator is mounted on a second mobile unit, and wherein the first and second mobile units help align the turbine and the generator.

3. The system of claim 1, wherein the coupling system is configured to cover the opening within the turbine enclosure during transport of the first mobile unit.

4. The system of claim 1, wherein the sliding system comprises at least one set of rails configured to support each of the first and second components.

5. The system of claim 4, wherein the first and second components are configured to be laterally displaced along the rails to expose the opening within the turbine enclosure.

6. The system of claim 1, wherein a removable fastener secures the first component to the second component during transport of the first mobile unit.

7. The system of claim 1, wherein the removable fastener is configured to be removed prior to separating the first and second components in opposite directions.

8. The system of claim 1, wherein each of the first and second components comprises a handle, and wherein the handle is configured to be engaged to separate the first and second components of the coupling system in opposite directions along the sliding system.

9. The system of claim 1, wherein the coupling system is coupled to a drive system configured to automatically separate the first and second components in opposite directions along the sliding system.

10. The system of claim 9, wherein the drive system comprises a controller configured to independently coordinate a lateral displacement of the first and second components in opposite directions along the sliding system.

11. A system, comprising:
a first mobile unit configured to support a turbine, wherein the turbine is enclosed within a turbine enclosure; and
a coupling system disposed on an exterior surface of the turbine enclosure, wherein the coupling system comprises a first component and a second component mounted on a sliding system, and wherein the first and second components are separated to a first distance along the sliding system to expose an alignment guide disposed within the turbine enclosure.

12. The system of claim 11, wherein the alignment guide is configured to guide a coupling between the turbine and a shaft associated with a generator.

13. The system of claim 12, wherein the generator is mounted on a second mobile unit.

14. The system of claim 11, wherein the first component and the second component are configured to separate in opposite directions along the sliding system to expose an opening within the turbine enclosure.

15. The system of claim 11, wherein the sliding system comprises a set of rails coupled to the first and the second components.

16. The system of claim 15, comprising a stopping mechanism configured to stop a lateral movement of each of the first and second components along the sliding system at the first distance.

17. A system, comprising:
a first mobile unit supporting a turbine, wherein the turbine is disposed within a turbine enclosure;
a second mobile unit supporting a generator; and
a coupling system mounted on a sliding system, wherein the coupling system is disposed on an exterior surface of the turbine enclosure, and wherein the coupling system is configured to be displaced along the sliding system to expose an opening through the turbine enclosure, and wherein the turbine is coupled to the generator through the opening.

18. The system of claim 17, wherein the first mobile unit comprises a first trailer and the second mobile unit comprises a second trailer.

19. The system of claim 17, wherein a shaft of the generator is configured to be coupled to the turbine through the opening within the turbine enclosure.

20. The system of claim 17, comprising an alignment guide disposed within the turbine enclosure configured to guide a coupling between the generator and the turbine, wherein the coupling system is displaced to expose the alignment guide.
